(19) United States
(12) Patent Application Publication
(10) Pub. No.: US 2011/0017674 A1
(43) Pub. Date: Jan. 27, 2011

(54) Using Magnets or Electromagnets to Move Sewage Sludge

(76) Inventor: Michael Anthony Schober, Lancaster, PA (US)

Correspondence Address: Michael A. Schober, 735 Westover Drive, Lancaster, PA, 17601, US

(21) Appl. No.: 12/796,893

(22) Filed: Jun. 9, 2010

Related U.S. Application Data
(60) Provisional application No. 61/228,944, filed on Jul. 27, 2009.

(51) Int. Cl. C02F 1/48

(52) U.S. Cl. 210/695

(57) ABSTRACT

In some domestic and industrial sewage treatment strategies, a powder of magnetized material is added to an aeration chamber, and aeration is conducted. The mixture is then sent to a sedimentation chamber, and solid-liquid separation is conducted. A portion of the precipitated sludge is returned to the aeration chamber as return sludge and reused. Sedimented sludge is highly concentrated, due to the density of the magnetized material. Traditionally, the settled sludge is removed from the sedimentation tank by slowly scraping the biomass towards a central hopper. The traditional sludge scraping mechanism is large, bulky and difficult to maintain. Magnets or electromagnets will be used to move the biomass to a predetermined destination for removal, thus eliminating the need for the bulky scraper mechanism.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

In some domestic and industrial sewage treatment strategies, a powder of magnetized material is added to an aeration chamber, and aeration is conducted. The mixture is then sent to a sedimentation chamber, and solid-liquid separation is conducted. A portion of the precipitated sludge is returned to the aeration chamber as return sludge and reused. Sedimented sludge is highly concentrated, due to the density of the magnetized material. Traditionally, the settled sludge is removed from the sedimentation tank by slowly scraping the biomass towards a central hopper. The traditional sludge scraping mechanism is large, bulky and difficult to maintain. Furthermore, the movement of the scraper causes currents within the clarifier which cause the sludge to bulk and billow. In lieu of the large scraper mechanism, magnets or electromagnets will be used to move the biomass to a predetermined destination for removal, thus eliminating the need for the bulky scraper mechanism. The electromagnets will be automated electronically to turn on and off in a cyclic manner to propel the sewage sludge in the desired direction. Similarly, non-electromagnets could be automatically moved to create the same effect.

### BRIEF SUMMARY OF THE INVENTION

In lieu of the large, bulky and difficult to maintain mechanical scraping mechanism, this invention will utilize the now magnetic characteristics of the floc to move it across the tank floor to a central collection point. Much like using electromagnets to propel trains or roller coasters, electromagnets can be used to move the settled, magnetic sludge to a central collection point. Similarly, conventional magnets can me automatically moved to create the same motive effect. By automating when the magnets are energized in a series, the movement of sludge across the bottom of the tank can be closely controlled. A series of magnets located on the bottom of the sedimentation tank will be energized in series, thus drawing the sludge closer and closer to the desired location. The object of the invention is to provide an alternative means to move a metallically charged floc. This means is more efficient than the current state of the technology.

### BRIEF DESCRIPTION OF SEVERAL VIEWS OF THE DRAWING

Not Applicable.

### DETAILED DESCRIPTION OF THE INVENTION

The present invention relates to the use of magnets or electromagnets to move settled sludge across the bottom of a sedimentation tank without the use of moving equipment. More particularly, the present invention will be used to move an activated sludge sedimentation that has an accelerating agent added to it which can concentrate sedimented sludge in a sedimentation chamber of an activated sludge processing system.

Waste water, such as sewage, has been conventionally purified using an activated sludge processing system. The main components of the activated sludge processing system are an aeration chamber and a sedimentation chamber. In this system, waste water is first brought to an aeration chamber where activated sludge is stored. Activated sludge is an aggregate of various microorganisms. The waste water is aerated and mixed with the activated sludge. Organic matter in the waste water is biologically oxidized and broken down. A portion of this oxidized organic matter is converted to activated sludge (microorganism biomass), and another portion of the oxidized organic matter is broken down to carbon dioxide gas and water. The activated sludge forms flocculate clumps (“flocs”), and floats in the mixed liquor.

Next, the mixed liquor in the aeration chamber is transported to the sedimentation chamber. Natural sedimentation of activated sludge by the action of gravity occurs, producing a solid-liquid separation of the above mixed liquor into a supernatant and sedimented sludge. A portion of the sedimented sludge is returned to the aeration chamber as return sludge and is recycled in order to maintain the concentration of activated sludge in the aeration chamber at a set value.

The main drawback of the conventional activated sludge processing system described above is that organic matter in the waste water is not efficiently converted to activated sludge in the aeration chamber. Furthermore, solid-liquid separation of the mixed liquor into sedimented sludge and supernatant in the sedimentation chamber occurs slowly. As a result, the concentration of sedimented sludge is low.

Furthermore, if the sedimented sludge is at a low concentration, the amount that must be returned to the aeration chamber to maintain the concentration of activated sludge in the aeration chamber at a set value becomes large. This results in a shortened aeration time used for purifying the water, and leads to inadequate processing. Therefore, to maximize the operating efficiency of the aeration chamber, the sedimented sludge must be highly concentrated. In other words, the suspended solid (SS) concentration in the mixed liquor (ML) which is to be returned to the aeration chamber (hereinafter “the MLSS”) must be increased.

The difference in specific gravity between activated sludge and water is small. Therefore, natural sedimentation of activated sludge in the sedimentation chamber occurs slowly. At times, bulking occurs, and sedimentation no longer occurs. In addition, even in the absence of bulking, the sedimented sludge obtained by natural sedimentation is not highly concentrated.

Furthermore, if organic matter or the like is localized in the waste water, clumped flocs are not generated. Instead, filamentous bulking masses are formed during the aeration step. The sludge is no longer sedimented in the sedimentation chamber. When this occurs, not only is return sludge not generated, but sludge may overflow from the sedimentation chamber.

Several solutions to these problems have been proposed. An iron or nickel metal powder is added to the aeration chamber. The iron or nickel metal powder is stirred and retained in the activated sludge. Since iron or nickel has a density of up to five times that of the floc, the floc will now settle quickly and efficiently.

Traditionally, this settled sludge is removed from the sedimentation tank through the use of a slowly moving scraping mechanism which plows the settled sludge across the bottom of the tank to a central collection point.

In lieu of the mechanical scraping mechanism, this invention will utilize the now magnetic characteristics of the floc to move it across the tank floor to a central collection point. Much like using electromagnets to propel trains or roller coasters, electromagnets can be used to move the settled, magnetic sludge to a central collection point.

By automating when the magnets are energized in a series, the movement of sludge across the bottom of the tank can be closely controlled. A series of magnets located on the bottom of the sedimentation tank will be energized in series, thus drawing the sludge closer and closer to the desired location.

It is an object of the present invention to overcome the limitations of the prior art.

It is another object of the present invention to provide a method for collecting settled sludge without the need for mechanical equipment.

Briefly stated, a powder of magnetized material is added to an aeration chamber, and aeration is conducted. The mixture is then sent to a sedimentation chamber, and solid-liquid separation is conducted. A portion of the precipitated sludge is returned to the aeration chamber as return sludge and reused. Sedimented sludge is highly concentrated, due to the action of the magnetized material. By returning a portion to the aeration chamber as return sludge, the biomass concentration becomes high, and high load operation in the aeration chamber can be achieved.

According to an embodiment of the present invention, a method for removing the settled sludge from the tank comprises the steps of sequencing electromagnets to propel the settled sludge in the desired direction.

Typical traditional clarifiers contain a sludge scraper mechanism on the bottom of the sedimentation tank. This invention proposes to replace these large, bulky and expensive to operate scrapers with significantly more efficient magnets.

What is claimed is:

1. A method for removing sludge sedimentation from a sedimentation tank without the moving parts of a scraper mechanism comprising the steps of;
permanently magnetizing particles of magnetic powder to form particles of permanently magnetized powder;
adding said particles of permanently magnetized powder to an aeration chamber containing a mixed liquor;
said mixed liquor including activated sludge and waste water;
mixing said particles of permanently magnetized powder with said mixed liquor to form a mixture;
transferring said mixture to a sedimentation chamber;
sedimenting said activated sludge in said sedimentation chamber to form a sedimented sludge;
separating said sedimented sludge from said mixed liquor; and
removing said sedimented sludge from the tank by use of moving magnets or sequencing electromagnets.
